(19) United States
(12) Patent Application Publication
(10) Pub. No.: US 2017/0290109 A1
(43) Pub. Date: Oct. 5, 2017

(54) LED POWERING CIRCUIT

(71) Applicant: Lighting Science Group Corporation, Cocoa Beach, FL (US)

(72) Inventor: Yong Jiang, Melbourne, FL (US)

(73) Assignee: Lighting Science Group Corporation, Cocoa Beach, FL (US)

(21) Appl. No.: 15/474,673

(22) Filed: Mar. 30, 2017

Related U.S. Application Data
(60) Provisional application No. 62/316,160, filed on Mar. 31, 2016.

(51) Int. Cl. H05B 33/08

(52) U.S. Cl. CPC H05B 33/089; H05B 33/0842

(57) ABSTRACT

A circuit to provide power to a load includes a first diode having a cathode connectable to a second terminal of a PTC thermistor and an anode connectable to a first node of the load. The anode of a second diode is connectable to the second terminal of the PTC thermistor and the cathode thereof is connectable to a second node of the load. The anode of a third diode is connectable to the anode of the first diode and the first node of the load and the cathode thereof is connectable to a neutral line of an AC power source. The anode of a fourth diode is connectable to the neutral line of the AC power source and the cathode thereof is connectable to the cathode of the second diode and the first node of the load.

### RELATED APPLICATIONS

This application claims the benefit under 35 U.S.C. §119(e) of U.S. Provisional Patent Application Ser. No. 62/316,160 filed on Mar. 31, 2016 and titled LED Powering Circuit, the entire content of which is incorporated herein by reference

### FIELD OF THE INVENTION

The present invention relates to a power conditioning circuit for electronic devices, including LED devices.

### BACKGROUND

The powering of LED circuits has required a balance dictated by the voltage needs of the LEDs being powered and the reduction in performance of the LEDs as more current is delivered thereto causing an increased operating temperature of the LEDs, degrading their performance. Traditional solutions to these problems have historically required extensive circuitry to provide adequate voltage smoothing, regulation, or complicated temperature sensing and control circuitry to respond to sensed temperatures. Accordingly, there is a need in the art for a simple and inexpensive LED powering circuit that can dynamically address and minimize LED performance degradation.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a circuit for providing power to a load comprising a positive temperature coefficient (PTC) thermistor comprising a first terminal positioned in electrical communication with a live wire of an alternating current (AC) power source and a plurality of diodes. The plurality of diodes may comprise a first diode positioned such that a cathode thereof is electrically connected to a second terminal of the PTC thermistor and an anode thereof is electrically connected to a first node of the load, a second diode positioned such that an anode thereof is electrically connected to the second terminal of the PTC thermistor and a cathode thereof is electrically connected to a second node of the load, a third diode positioned such that an anode thereof is electrically connected to the anode of the first diode and the first node of the load and a cathode thereof is electrically connected to a neutral line of the AC power source, and a fourth diode positioned such that an anode thereof is electrically connected to the neutral line of the AC power source and a cathode thereof is electrically connected to the cathode of the second diode and the first node of the load.

In some embodiments, the circuit may further comprise a fuse positioned intermediate the PTC thermistor and the live wire of the AC power source. In some embodiments, the diodes of the plurality of diodes may have equal reverse voltage ratings that may be within the range from 110 volts to 120 volts, within the range from 220 volts to 240 volts, or 400 volts.

In some embodiments, the diodes of the plurality of diodes may have equivalent current ratings that may be 1 ampere or within the range from 0.5 amperes to 1 ampere.

### BRIEF DESCRIPTION OF THE DRAWINGS

FIG. 1 is a schematic depiction of a power conditioning circuit according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a power conditioning circuit for electronic devices. The power conditioning circuit advantageously reduces the complexity of circuitry needed to convert an AC electrical supply to DC power for use by electronic devices, including, but not limited to, LED devices.

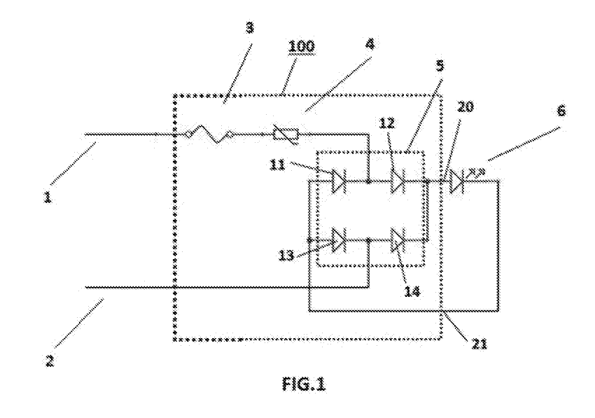

Referring now to FIG. 1, a circuit 100 according to an embodiment of the invention is presented. The circuit 100 may comprise a positive temperature coefficient (PTC) thermistor 4 and a plurality of diodes 5, which may be connected to a load 6. The thermistor 4 may be electrically connected to a live wire 1 of an AC electricity source. In some embodiments, a fuse 3 may be electrically connected intermediate the live wire 1 of the AC source and the thermistor 4. The current rating of the fuse 3 may be selected responsive to the current requirements of the load 6.

The thermistor 4 may have a room temperature resistor within the range from 60 to 100 ohms and a transition current within the range from 50 mA to 100 mA.

The plurality of diodes 5 may be rectifier diodes as are known in the art and may comprise a first diode 11 positioned such that a cathode thereof is electrically connected to a terminal of the thermistor 4 and an anode thereof is connected to an electrical node 21 of the load 6. The plurality of diodes 5 may further comprise a second diode 12 positioned such that an anode thereof is electrically connected to the same terminal of the thermistor 4 as the cathode of the first diode 11 and a cathode thereof is electrically connected to another electrical node 20 of the load 6. The plurality of diodes 5 may further comprise a third diode 13 positioned such that an anode thereof is electrically connected to the anode of the first diode 11 and to the electrical node 21 of the load 6 and that a cathode thereof is electrically connected to a neutral line 2 of the AC source. The plurality of diodes 5 may further comprise a fourth diode 14 positioned such that an anode thereof is electrically connected to the neutral line 2 of the AC source and a cathode thereof is electrically connected to the cathode of the second diode 12 and the electrical node 20 of the load.

In some embodiments, the plurality of diodes 5 may have approximately equal reverse voltage ratings. The plurality of diodes 5 may be selected based on the voltage of the AC source. For example, where the AC source has a voltage within the range from 110 volts to 120 volts, each of the plurality of diodes may have a reverse voltage rating of approximately 200 volts. Where the AC source has a voltage within the range from 220 volts to 240 volts, each of the plurality of diodes 5 may have a reverse voltage rating of approximately 400 volts.

Additionally, the plurality of diodes 5 may have approximately equal current ratings. The current may depend on the voltage delivered by the AC source and the power requirements of the load 6. In the present embodiment, where the load 6 is an LED device, and where the AC source has a voltage within the range from 110 volts to 120 volts, the plurality of diodes 5 may each have a current rating of 1 amp. Where the AC source has a voltage within the range from 220 volts to 240 volts, the plurality of diodes may each have a current rating within the range from 0.5 amps to 1 amp.

While the present embodiment depicts the load 6 as a single LED, it is contemplated that the bad 6 may comprise any type of LED, including chip-on-board LEDs, multiple LEDs soldered on a printed circuit board (PCB), multiple strings of LEDs, in series, parallel, or combinations thereof, a filament LED package, and the like.

The circuit 100 advantageously provides current-limiting functionality so as to prevent the burnout of the bad 6 while also providing power conditioning functionality so as to enable the operation of the bad 6 while increasing the efficiency of the operation of the bad 6.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A circuit for providing power to a load comprising:
a positive temperature coefficient (PTC) thermistor comprising a first terminal positioned in electrical communication with a live wire of an alternating current (AC) power source; and
a plurality of diodes comprising
a first diode positioned such that a cathode thereof is electrically connected to a second terminal of the PTC thermistor and an anode thereof is electrically connected to a first node of the load,
a second diode positioned such that an anode thereof is electrically connected to the second terminal of the PTC thermistor and a cathode thereof is electrically connected to a second node of the load,
a third diode positioned such that an anode thereof is electrically connected to the anode of the first diode and the first node of the load and a cathode thereof is electrically connected to a neutral line of the AC power source, and
a fourth diode positioned such that an anode thereof is electrically connected to the neutral line of the AC power source and a cathode thereof is electrically connected to the cathode of the second diode and the first node of the load.

2. The circuit according to claim 1 further comprising a fuse positioned intermediate the PTC thermistor and the live wire of the AC power source.

3. The circuit according to claim 1 wherein the diodes of the plurality of diodes have equal reverse voltage ratings.

4. The circuit according to claim 1 wherein each diode of the plurality of diodes has a reverse voltage rating within the range from 110 volts to 120 volts.

5. The circuit according to claim 1 wherein the plurality of diodes each have a reverse voltage rating within the range from 220 volts to 240 volts.

6. The circuit according to claim 1 each diode of wherein the plurality of diodes has a reverse voltage rating of 400 volts.

7. The circuit according to claim 1 wherein the diodes of the plurality of diodes have equivalent current ratings.

8. The circuit according to claim 1 wherein the plurality of diodes each have a current rating of 1 ampere.

9. The circuit according to claim 1 wherein the plurality of diodes each have a current rating within the range from 0.5 amperes to 1 ampere.

10. A circuit for providing power to a load comprising:
a positive temperature coefficient (PTC) thermistor comprising a first terminal positioned in electrical communication with a live wire of an alternating current (AC) power source;
a plurality of diodes comprising
a first diode positioned such that a cathode thereof is electrically connected to a second terminal of the PTC thermistor and an anode thereof is electrically connected to a first node of the load,
a second diode positioned such that an anode thereof is electrically connected to the second terminal of the PTC thermistor and a cathode thereof is electrically connected to a second node of the load,
a third diode positioned such that an anode thereof is electrically connected to the anode of the first diode and the first node of the load and a cathode thereof is electrically connected to a neutral line of the AC power source, and
a fourth diode positioned such that an anode thereof is electrically connected to the neutral line of the AC power source and a cathode thereof is electrically connected to the cathode of the second diode and the first node of the load; and
a fuse positioned intermediate the PTC thermistor and the live wire of the AC power source;
wherein each diode of the plurality of diodes has a reverse voltage rating within the from one of 110 volts to 120 volts and 220 volts to 240 volts; and
wherein each diode of the plurality of diodes has a current rating within the range from 0.5 amperes to 1 ampere.
